(19) United States
(12) Patent Application Publication
(10) Pub. No.: US 2026/0058029 A1
(43) Pub. Date: Feb. 26, 2026

(54) Nuclear-energy storage integrated lead-based reactor with autonomous load-following function

(71) Applicant: SHANGHAI JIAO TONG UNIVERSITY, Shanghai (CN)

(72) Inventors: Xiaojing LIU, Shanghai (CN); Lin ZHANG, Shanghai (CN); Chang DENG, Shanghai (CN); Tengfei ZHANG, Shanghai (CN); Hui HE, Shanghai (CN)

(73) Assignee: SHANGHAI JIAO TONG UNIVERSITY, Shanghai, SH (CN)

(21) Appl. No.: 19/379,677

(22) Filed: Nov. 4, 2025

(30) Foreign Application Priority Data
Jan. 24, 2025 (CN) 202510116109.X

(51) Int. Cl. G21C 7/28; G21C 1/02; G21C 1/32; G21C 7/32; G21C 15/02

(52) U.S. Cl. CPC G21C 7/28; G21C 1/02; G21C 1/322; G21C 7/32; G21C 15/02

(57) ABSTRACT

The nuclear-energy storage integrated lead-based reactor with an autonomous load-following function includes a reactor core, a phase change energy storage device, and a thermal energy utilization device; the reactor core is configured for heating a coolant, and the thermal energy utilization device is configured for absorbing heat in the coolant; the phase change energy storage device is provided at an inlet side of the reactor core, and configured for exchanging heat with the coolant, and a phase change temperature of the phase change energy storage device is consistent with a preset inlet temperature of the reactor core. The nuclear-energy storage integrated lead-based reactor has a natural circulation flow rate that is not easy to oscillate and diverge, the fuel assembly does not have the risk of overheating and melting, and the structural components are not easy to suffer from thermal fatigue, and it has high safety performance.

### CROSS-REFERENCE TO RELATED APPLICATION

This application claims priority to Chinese Patent Application No. 202510116109.X, filed on Jan. 24, 2025, titled “Nuclear-energy storage integrated lead-based reactor with autonomous load-following function” before the China National Intellectual Property Administration, the disclosure of which is incorporated herein by reference in entirety.

### TECHNICAL FIELD

The present disclosure relates to the field of lead-based reactor/lead-cooled fast reactor, and in particular to a nuclear-energy storage integrated lead-based reactor with an autonomous load-following function.

### BACKGROUND

Natural-circulation small lead-based reactors are widely used in special operating environments such as deep space and deserts due to their high safety, ease of miniaturization, and high mobility. Because external operations do not always require rated power, the reactor must adjust its power according to the external power demand. Currently, there are two main power adjustment methods: autonomous load following and passive load following.

Among them, the power of the lead-based reactor with autonomous load following can automatically change with external load changes without the need for additional intervention. It relies on the negative feedback characteristic of the effective neutron multiplication factor keff within the lead-based reactor to work, and then changes the core power by adjusting the natural-circulation flow rate. However, during the autonomous load-following process, since short-term temperature changes are difficult to match with flow changes, it causes divergence of the natural circulation flow rate, and transient temperature fluctuations within the reactor core will also cause flow oscillation and divergence. In addition, the response speed of the steam generator's external load is relatively fast, while it takes a certain amount of time for the core to re-establish natural circulation, therefore its response speed is slow, which can easily lead to excessive core temperature. The drastic heating and cooling will cause thermal fatigue of structural components. The core power cannot be reduced in a short period of time, causing the core to bear this part of the excess heat, which can easily cause danger.

### SUMMARY

The purpose of the present disclosure is to provide a nuclear-energy storage integrated lead-based reactor with an autonomous load-following function, so as to alleviate the technical problems of the autonomous load-following lead-based reactor in the prior art, such as easy flow rate divergence, easy thermal fatigue of structural components, and high risk.

The present disclosure provides a nuclear-energy storage integrated lead-based reactor with an autonomous load-following function, comprising a reactor core, a phase change energy storage device, and a thermal energy utilization device;

the reactor core is configured for heating a coolant, and the thermal energy utilization device is configured for absorbing heat in the coolant; the phase change energy storage device is provided at an inlet side of the reactor core, and configured for exchanging heat with the coolant, and a phase change temperature of the phase change energy storage device is consistent with a preset inlet temperature of the reactor core.

According to some embodiments of the present disclosure, a flow distributor is provided at the inlet side of the reactor core.

According to some embodiments of the present disclosure, the phase change energy storage device is installed in the flow distributor.

According to some embodiments of the present disclosure, a fixed reflective layer and an adjustable reflective layer are provided on the outside of the reactor core;

the fixed reflective layer is fixedly arranged around the reactor core and has a notch for neutron leakage; the adjustable reflective layer is capable of shielding the notch of the fixed reflective layer, and the adjustable reflective layer is configured to be movable relative to the fixed reflective layer to adjust a shielding area of the notch of the fixed reflective layer.

According to some embodiments of the present disclosure, the adjustable reflective layer is capable of completely shielding the whole notch of the fixed reflective layer.

According to some embodiments of the present disclosure, the adjustable reflective layer is capable of completely opening the whole notch of the fixed reflective layer.

According to some embodiments of the present disclosure, the adjustable reflective layer is arranged around the reactor core, has a notch for neutron leakage, and the adjustable reflective layer is configured to rotate around the reactor core;

the fixed reflective layer is arranged between the adjustable reflective layer and the reactor core, or the adjustable reflective layer is arranged between the fixed reflective layer and the reactor core.

According to some embodiments of the present disclosure, the adjustable reflective layer has N rotary arc bodies for reflecting neutrons, and the N rotary arc bodies are arranged at intervals around the reactor core; the fixed reflective layer has N fixed arc bodies for reflecting neutrons, and the N fixed arc bodies are arranged at intervals around the reactor core;

the N fixed arc bodies and the N rotary arc bodies are evenly distributed around the reactor core, and N is a positive integer.

According to some embodiments of the present disclosure, a central angle corresponding to one fixed arc body and a central angle corresponding to one rotary arc body are both 180°/N; and/or,
N=4.

According to some embodiments of the present disclosure, a neutron shielding layer surrounding the reactor core is provided on the outside of the reactor core, and the fixed reflective layer and the adjustable reflective layer are both located on an inner side of the neutron shielding layer.

According to some embodiments of the present disclosure, the thermal energy utilization device comprises a steam generator.

Compared with the prior art, the present disclosure has the following beneficial effects:

The heat generated when the core is working can heat the low-temperature coolant and increase the coolant temperature; when the high-temperature coolant after absorbing heat flows through the thermal energy utilization device, it can release heat to the thermal energy utilization device, so that the thermal energy utilization device can convert the absorbed heat energy into other forms of energy and provide it to the load, or directly provide thermal energy to the load to meet the working needs of the load.

When the load is running steadily/smoothly, the heat released by the high-temperature coolant to the thermal energy utilization device remains unchanged, and the temperature of the low-temperature coolant after heat release is consistent with the preset inlet temperature of the core. Since the phase change temperature of the phase change energy storage device is consistent with the preset inlet temperature of the core, when the low-temperature coolant after heat release flows through the phase change energy storage device, the phase change energy storage device will not have heat interaction with the low-temperature coolant, that is, the phase change energy storage device remains stable, the temperature of the low-temperature coolant basically does not change, and the core inlet temperature Tin will not change accordingly. When the load changes, the outlet temperature Tout of the thermal energy utilization device will first respond and fluctuate, and the low-temperature coolant will pass through the phase change energy storage device before entering the core. Since the phase change temperature of the phase change energy storage device is consistent with the inlet temperature of the core, the low-temperature coolant with temperature fluctuations will interact with the phase change energy storage device, so that the temperature of the low-temperature coolant flowing through the phase change energy storage device can be kept consistent with the phase change temperature of the phase change energy storage device to maintain the constant core inlet temperature Tin; when the external load continues to change, the phase change energy storage device will continue to compensate for the changes caused by the external load until it stabilizes; after the phase change energy storage device stabilizes, it will gradually keep consistent with the outlet temperature of the thermal energy utilization device. At this time, the core inlet temperature Tin gradually changes, and the core temperature changes accordingly. The negative feedback characteristic of the effective neutron multiplication factor keff comes into play, and then the core power gradually changes, and the natural circulation is re-established.

Therefore, the nuclear-energy storage integrated lead-based reactor with an autonomous load-following function provided by the present disclosure can buffer thermal changes through the phase change energy storage device, so that the temperature changes slowly, and it can reduce the impact of instantaneous temperature changes on the balance between flow rate and thermal change, thereby achieving a self-stabilizing effect. As a result, the natural circulation flow rate is not easy to oscillate and diverge, and the structural components are not prone to thermal fatigue; in addition, the phase change energy storage device can realize energy interaction, greatly reducing the core temperature fluctuation while offsetting the temperature accumulation of the core. The response time of the core no longer affects safety, which can enhance the safety performance of the lead-based reactor.

### BRIEF DESCRIPTION OF THE DRAWINGS

In order to more clearly illustrate the embodiments of the present disclosure or the technical solutions in the prior art, the following briefly introduces the drawings for the description of the embodiments or the prior art. Obviously, the drawings described below are merely part of embodiments of the present disclosure. For ordinary technicians in this field, other drawings can be obtained based on the provided drawings without paying any creative work.

FIG. 1 is a schematic structural view of a nuclear-energy storage integrated lead-based reactor with an autonomous load-following function provided by the present disclosure;

FIG. 2 is a diagram comparing the stability of a nuclear-energy storage integrated lead-based reactor with an autonomous load-following function provided by the present disclosure and a lead-based reactor with autonomous load-following function in the prior art when the high load decreases;

FIG. 3 is a schematic diagram showing changes in core inlet and outlet temperatures and natural circulation flow rate of a lead-based reactor with autonomous load-following function in the prior art when high load decreases;

FIG. 4 is a schematic diagram showing changes in core inlet and outlet temperatures and natural circulation flow rate of a nuclear-energy storage integrated lead-based reactor with an autonomous load-following function provided by the present disclosure when the high load decreases;

FIG. 5 is a diagram comparing the stability of a nuclear-energy storage integrated lead-based reactor with an autonomous load-following function provided by the present disclosure and a lead-based reactor with autonomous load-following function in the prior art when the low load increases;

FIG. 6 is a schematic structural diagram of the main structure of a nuclear-energy storage integrated lead-based reactor with an autonomous load-following function provided by the present disclosure in a first state;

FIG. 7 is a schematic structural view of the main structure of a nuclear-energy storage integrated lead-based reactor with an autonomous load-following function provided by the present disclosure in the second state;

FIG. 8 is a schematic structural view of the main structure of a nuclear-energy storage integrated lead-based reactor with an autonomous load-following function provided by the present disclosure in the third state.

### DESCRIPTION OF REFERENCE NUMERALS

100—reactor core/core;
200—phase change energy storage device;
300—thermal energy utilization device;
400—fixed reflective layer;
500—adjustable reflective layer;
600—neutron shielding layer.

### DETAILED DESCRIPTION OF EMBODIMENTS

The technical solutions of the present disclosure will be clearly and completely described below with reference to the accompanying drawings. Obviously, the embodiments described are only part of the present disclosure, not the whole of it. All other embodiments obtained by ordinary technicians in this field based on the embodiments of the present disclosure without making any creative efforts shall fall within the scope of protection of the present disclosure.

The present disclosure will be further described in detail below through specific implementation examples in conjunction with the accompanying drawings.

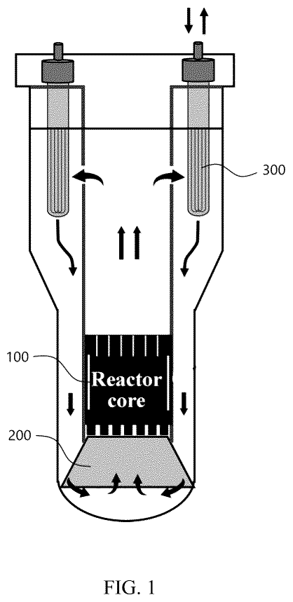

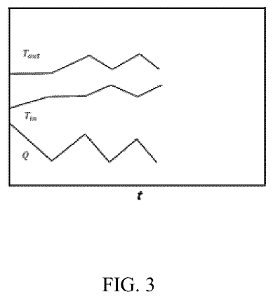

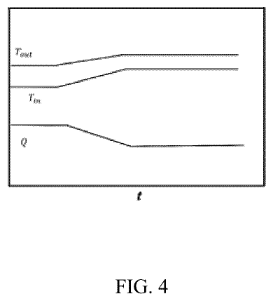

With reference to FIGS. 1 to 5, this embodiment provides a nuclear-energy storage integrated lead-based reactor with an autonomous load-following function, which includes a reactor core 100, a phase change energy storage device 200, and a thermal energy utilization device 300; the reactor core 100 is used to heat a coolant, and the thermal energy utilization device 300 is used to absorb heat in the coolant; the phase change energy storage device 200 is arranged on the inlet side of the reactor core 100, and the phase change energy storage device 200 is used to perform thermal interaction with the coolant, and the phase change temperature of the phase change energy storage device 200 is consistent with the preset inlet temperature of the reactor core 100.

The heat generated when the core 100 is working can heat the low-temperature coolant and increase the coolant temperature; when the high-temperature coolant after absorbing heat flows through the thermal energy utilization device 300, it can release heat to the thermal energy utilization device 300, so that the thermal energy utilization device 300 can convert the absorbed heat energy into other forms of energy and provide it to the load, or directly provide thermal energy to the load to meet the working requirements of the load.

When the load is running steadily/smoothly, the heat released by the high-temperature coolant to the thermal energy utilization device 300 remains unchanged, and the temperature of the low-temperature coolant after heat release is consistent with the preset inlet temperature of the core 100. Since the phase change temperature of the phase change energy storage device 200 is consistent with the preset inlet temperature of the core 100, when the low-temperature coolant after heat release flows through the phase change energy storage device 200, the phase change energy storage device 200 will not have heat interaction with the low-temperature coolant, that is, the phase change energy storage device 200 remains stable, the temperature of the low-temperature coolant basically does not change, and the core inlet temperature Tin will not change accordingly. When the load changes, the outlet temperature Tout of the thermal energy utilization device 300 will first respond and fluctuate, and the low-temperature coolant will pass through the phase change energy storage device 200 before entering the core 100. Since the phase change temperature of the phase change energy storage device 200 is consistent with the inlet temperature of the core 100, the low-temperature coolant with temperature fluctuations will interact with the phase change energy storage device 200 for heat, so that the temperature of the low-temperature coolant flowing through the phase change energy storage device 200 can be kept consistent with the phase change temperature of the phase change energy storage device 200 to maintain the constancy of the core inlet temperature Tin; when the external load continues to change, the phase change energy storage device 200 will continue to compensate for the changes caused by the external load until it stabilizes; after the phase change energy storage device 200 stabilizes, it will gradually keep consistent with the outlet temperature of the thermal energy utilization device 300. At this time, the core inlet temperature Tin gradually changes, and the temperature of the core 100 changes accordingly. The negative feedback characteristic of the effective neutron multiplication factor keff takes effect, and then the core power gradually changes, and the natural circulation is re-established.

Therefore, the nuclear-energy storage integrated lead-based reactor with an autonomous load-following function provided in this embodiment can buffer thermal changes through the phase change energy storage device 200, so that the temperature changes slowly, and it can reduce the impact of instantaneous temperature changes on the balance between flow rate and thermal change, thereby achieving a self-stabilizing effect. As a result, the natural circulation flow rate is not easy to oscillate and diverge, and the structural components are not easy to suffer from thermal fatigue; in addition, the phase change energy storage device 200 can realize energy interaction, greatly reducing the core temperature fluctuation while offsetting the temperature accumulation of the core 100. The response time of the core 100 no longer affects safety, which can enhance the safety performance of the lead-based reactor.

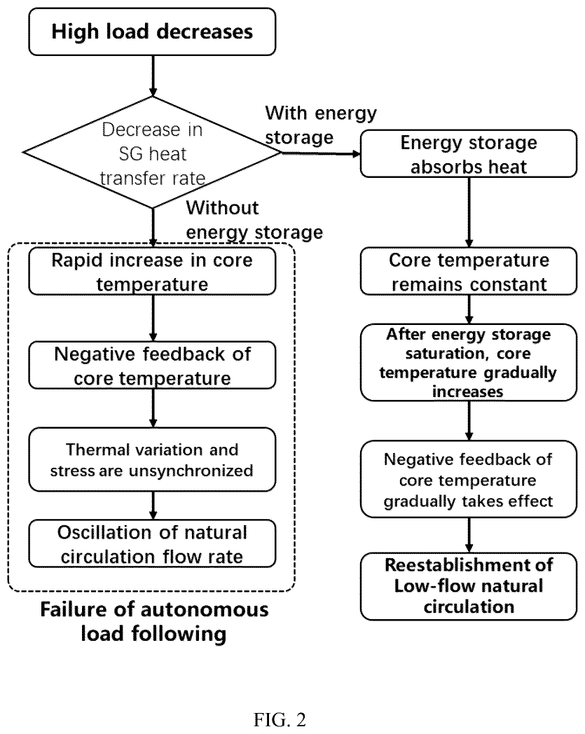

Specifically, referring to FIGS. 2-4, when the external load power is reduced, the heat transfer capacity of the thermal energy utilization device 300 decreases rapidly. Due to the presence of the phase change energy storage device 200, the excess heat of the superheated fluid at the outlet of the thermal energy utilization device 300 is absorbed by the phase change energy storage device 200, thereby maintaining a constant core inlet temperature Tin. In other words, the insufficient cooling capacity of the thermal energy utilization device 300 for the coolant caused by the external load power reduction is compensated by the phase change energy storage device 200, and the core 100 continues to operate at full power. The excess power is absorbed by the phase change energy storage device 200, so the load following and response time of the core 100 will not affect the safety of the core 100. When the phase change energy storage device 200 gradually saturates, the core inlet temperature Tin slowly increases. Since the core inlet temperature Tin changes slowly, the core outlet temperature Tout has sufficient time to respond and increase in temperature, so the natural circulation flow rate gradually decreases. Because this process changes slowly, the core 100 does not overheat. Due to the negative feedback characteristic of the effective neutron multiplication factor keff, the reactivity of the core 100 gradually decreases. When the phase change energy storage device 200 is fully saturated, the core inlet temperature Tin matches the outlet temperature of the thermal energy utilization device 300, achieving a new equilibrium.

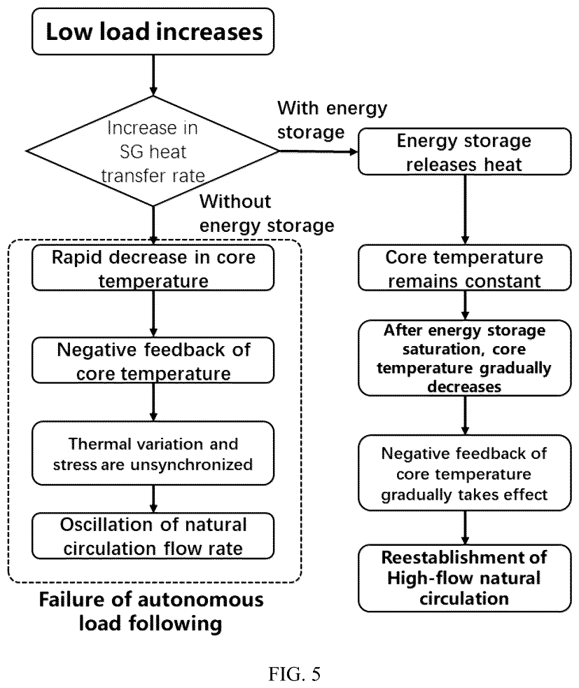

Correspondingly, as shown in FIG. 5, when the external load increases in power, the heat transfer capacity of the thermal energy utilization device 300 increases rapidly. Due to the presence of the phase change energy storage device 200, the supercooled fluid at the outlet of the thermal energy utilization device 300 absorbs heat from the phase change energy storage device 200, similarly maintaining a constant core inlet temperature Tin. In other words, the excessive cooling capacity of the thermal energy utilization device 300 for the coolant caused by the increase in external load power is compensated by the phase change energy storage device 200. The core 100 continues to operate at the original power, with the insufficient power being supplemented by the phase change energy storage device 200. Therefore, the load following and response time of the core 100 does not affect the safety of the core 100. When the phase change energy storage device 200 gradually becomes saturated, the core inlet temperature Tin slowly decreases. Since the core inlet temperature Tin changes slowly, the core outlet temperature Tout has sufficient time to respond and increase, resulting in a gradual increase in the natural circulation flow rate. Because this process changes slowly, the flow rate in core 100 is less susceptible to oscillation. Under the influence of the negative feedback characteristic of the effective neutron multiplication factor keff, the reactivity of the core 100 gradually increases. When the phase change energy storage device 200 is fully saturated, the core inlet temperature Tin matches the outlet temperature of the thermal energy utilization device 300, reaching a new equilibrium.

A flow distributor may be provided at the inlet side of the core 100 to achieve a flow conditioning effect.

Optionally, referring to FIG. 1, the phase change energy storage device 200 can be installed in the flow distributor to form a phase change energy storage and flow distribution combined structure, thereby realizing the effects of synchronous flow conditioning and temperature control. It is only necessary to design the internal structure of the flow distributor so that the phase change energy storage device 200 can be installed. There is no need to change the overall shape and size of the flow distributor. Thus, there is no need to adjust other structures, which is conducive to simplifying the structural design.

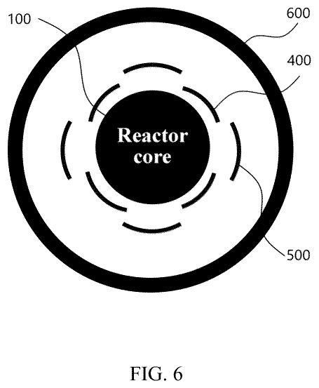

In addition, referring to FIGS. 6-8, a fixed reflective layer 400 and an adjustable reflective layer 500 may be disposed outside the core 100. The fixed reflective layer 400 is fixedly disposed around the core 100, and a notch is provided in the fixed reflective layer 400 to allow neutrons to leak/escape. Simultaneously, the adjustable reflective layer 500 is configured to shield/cover/block the notch in the fixed reflective layer 400 and is movable relative to the fixed reflective layer 400, so that the adjustable reflective layer 500 can adjust the shielding area of the notch in the fixed reflective layer 400. This allows the effective neutron multiplication factor keff of the core 100 to be adjusted, providing a wide adjustment range for the subcriticality (1−keff). This allows for better adjustment of the reactivity of the core 100 when the reactivity of the core 100 fluctuates. It should be noted that since the adjustable reflective layer 500 is arranged outside the core 100, the adjustable reflective layer 500 will not be affected by factors such as the large buoyancy inside the core 100 and the deformation of the mechanical channel when it moves. The adjustable reflective layer 500 can be smoothly adjusted, and then the subcriticality of the core 100 can be smoothly controlled, which improves safety.

During normal operation, just adjust keff to 1.

Optionally, the adjustable reflective layer 500 is configured to completely cover all the notches in the fixed reflective layer 400. In this way, the adjustable reflective layer 500 and the fixed reflective layer 400 can completely wrap the core 100, so that the neutrons leaked from the core 100 are fully reflected, thereby achieving the maximum effective neutron multiplication factor (effective multiplication coefficient) keff, at this time keff>1.

Furthermore, the adjustable reflective layer 500 is configured to completely open all the notches of the fixed reflective layer 400 to fully exert the function of each notch set in the fixed reflective layer 400. In this case, keff≤1.

Specifically, the adjustable reflective layer 500 is arranged around the core 100, a notch/notches are provided on the adjustable reflective layer 500 for neutron leakage, and the adjustable reflective layer 500 is arranged to be able to rotate around the core 100, which makes operation easier; on this basis, the fixed reflective layer 400 can be optionally arranged between the adjustable reflective layer 500 and the core 100, or the adjustable reflective layer 500 can be optionally arranged between the fixed reflective layer 400 and the core 100, so that the adjustable reflective layer 500 will not interfere with the fixed reflective layer 400 when rotating around the core 100. Therefore, when it is necessary to adjust the effective neutron multiplication factor keff of the lead-based reactor, the adjustable reflective layer 500 can be smoothly rotated to adjust the shielding area of the notch of the fixed reflective layer 400.

The adjustable reflective layer 500 can be configured with N rotary arc bodies, spaced apart around the core 100. This creates a notch between adjacent rotary arc bodies. Similarly, the fixed reflective layer 400 can be configured with N fixed arc bodies, spaced apart around the core 100. This creates a notch between adjacent fixed arc bodies. When a rotary arc body faces a notch in the fixed reflective layer 400, it obscures the notch. The notch in the fixed reflective layer 400 that faces the notch in the adjustable reflective layer 500 is then open, allowing neutrons to leak/escape through this open area. Evenly distributing the N fixed arc bodies and the N rotary arc bodies along the core 100 ensures that the open areas of the reflective layers are evenly distributed around the core 100, achieving optimal results. N is a positive integer.

Optionally, the central angle corresponding to the fixed arc and the central angle corresponding to the rotary arc can be set to be consistent, so that the distribution uniformity of the diffused and escaped neutrons can be further improved, and the effect is better.

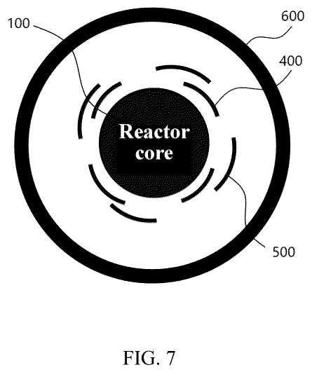

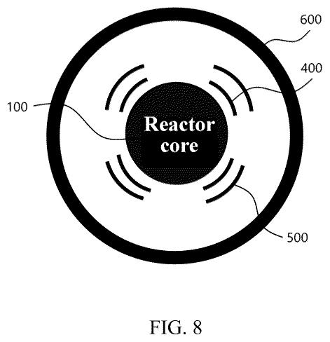

Optionally, the central angle corresponding to the fixed arc body and the central angle corresponding to the rotary arc body can be set to 180°/N. In this way, the overlapping area of the fixed arc body and the rotary arc body can be adjusted by controlling the movement of the adjustable reflective layer 500. Referring to FIG. 6, when the adjustable reflective layer 500 completely blocks the notch of the fixed reflective layer 400, the core 100 can be completely wrapped, and the effective neutron multiplication factor keff is greater than 1 at this time; referring to FIG. 7, when each rotary arc body partially overlaps with each fixed arc body, the notch of the fixed reflective layer 400 can be partially opened, and the smaller the overlapping area of the rotary arc body and the fixed arc body, the greater the subcriticality (1−keff), the smaller the effective neutron multiplication factor keff, and the weaker the chain nuclear reaction of the core 100. Referring to FIG. 8, in extreme cases, each rotary arc body is adjusted to completely overlap with fixed arc body, and the notch in the fixed reflective layer 400 can be completely opened, thereby minimizing the area of the notch in the fixed reflective layer 400 blocked by the adjustable reflective layer 500. At this time, the effective neutron multiplication factor keff is minimized, keff<1, achieving a rapid and safe shutdown and preventing the core 100 from melting. Referring to FIG. 7, during normal operation, the adjustable reflective layer 500 can be controlled to move so that half of the area of the rotary arc body overlaps with the fixed arc body. At this time, keff=1.

Specifically, N can be set to 4. Referring to FIG. 6, the state in which the rotary arc bodies are completely staggered from the fixed arc bodies and the adjustable reflective layer 500 completely shields the notches in the fixed reflective layer 400 can be used as the initial state. In this state, the core 100 is completely enclosed, the reactivity of the core 100 is maximized, and the effective neutron multiplication factor keff of the core is greater than 1. Referring to FIG. 8, when the adjustable reflective layer 500 is controlled to rotate 45°, the rotary arc bodies completely overlap with the fixed arc bodies, the notches in the fixed reflective layer 400 are completely opened, and the effective neutron multiplication factor keff is minimized, keff<1, achieving a rapid and safe shutdown.

Referring to FIGS. 6-8, a neutron shielding layer 600 surrounding the core 100 may be provided on the outside of the core 100, and both the fixed reflective layer 400 and the adjustable reflective layer 500 are provided on the inner side of the neutron shielding layer 600, that is, the neutron shielding layer 600 is provided in the outermost layer. The neutron shielding layer 600 can prevent the diffusion of radioactive particles and improve safety.

As an alternative, the subcriticality of the core 100 may be adjusted by controlling the diffusion and reflection of neutrons through other external devices.

Specifically, a steam generator may be used as the thermal energy utilization device 300. Of course, other devices capable of absorbing and utilizing heat may also be selected as the thermal energy utilization device 300.

The phase change heat Qₚ of the phase change energy storage device 200 can be expressed as: Qₚ=h*m_{pcm}; where h is the phase change enthalpy, and m_{pcm} is the total energy of the phase change energy storage device 200.

In summary, the embodiments of the present disclosure disclose a nuclear-energy storage integrated lead-based reactor with an autonomous load-following function, which overcomes many technical defects of traditional autonomous load-following lead-based reactors, such as: easy divergence of flow, easy occurrence of thermal fatigue in structural components, and high risk. The nuclear-energy storage integrated lead-based reactor with an autonomous load-following function provided by the embodiments of the present disclosure forms a buffer for thermal changes through the phase change energy storage device 200, so that the temperature changes slowly, which can reduce the impact of instantaneous temperature changes on the balance between flow rate and thermal change, and realize the self-stabilization of natural circulation disturbances. Therefore, the natural circulation flow is not easy to oscillate and diverge, and the structural components are not easy to thermal fatigue. In addition, the phase change energy storage device 200 can realize energy interaction, greatly reducing the temperature fluctuation of the core 100 while offsetting the temperature accumulation of the core 100. The response time of the core 100 no longer affects safety, which can enhance the safety performance of the lead-based reactor.

In the description of the present disclosure, it should be noted that, unless otherwise specified or limited, the term “mounted/installed” should be understood in a broad sense. For example, it can mean a fixed connection, a detachable connection, or an integral connection; it can mean a mechanical connection or an electrical connection; it can mean a direct connection or an indirect connection through an intermediate medium; it can mean internal communication between two components. Those skilled in the art will understand the specific meanings of the above terms in the present disclosure based on the specific circumstances.

Finally, it should be noted that the above embodiments are only used to illustrate the technical solutions of the present disclosure, rather than to limit it. Although the present disclosure has been described in detail with reference to the above embodiments, those skilled in the art should understand that they can still modify the technical solutions described in the above embodiments, or replace some or all of the technical features therein with equivalents. However, these modifications or replacements do not cause the essence of the corresponding technical solutions to deviate from the scope of the technical solutions of the embodiments of the present disclosure.

What is claimed is:

1. A nuclear-energy storage integrated lead-based reactor with an autonomous load-following function, comprising a reactor core, a phase change energy storage device, and a thermal energy utilization device;
the reactor core is configured for heating a coolant, and the thermal energy utilization device is configured for absorbing heat in the coolant; the phase change energy storage device is provided at an inlet side of the reactor core, and configured for exchanging heat with the coolant, and a phase change temperature of the phase change energy storage device is consistent with a preset inlet temperature of the reactor core;
a flow distributor is provided at the inlet side of the reactor core.

2. The nuclear-energy storage integrated lead-based reactor according to claim 1, wherein the phase change energy storage device is installed in the flow distributor.

3. The nuclear-energy storage integrated lead-based reactor according to claim 1, wherein a fixed reflective layer and an adjustable reflective layer are provided on the outside of the reactor core;
the fixed reflective layer is fixedly arranged around the reactor core and has a notch for neutron leakage; the adjustable reflective layer is capable of shielding the notch of the fixed reflective layer, and the adjustable reflective layer is configured to be movable relative to the fixed reflective layer to adjust a shielding area of the notch of the fixed reflective layer.

4. The nuclear-energy storage integrated lead-based reactor according to claim 3, wherein the adjustable reflective layer is capable of completely shielding the whole notch of the fixed reflective layer.

5. The nuclear-energy storage integrated lead-based reactor according to claim 3, wherein the adjustable reflective layer is capable of completely opening the whole notch of the fixed reflective layer.

6. The nuclear-energy storage integrated lead-based reactor according to claim 3, wherein the adjustable reflective layer is arranged around the reactor core, has a notch for neutron leakage, and the adjustable reflective layer is configured to rotate around the reactor core;
the fixed reflective layer is arranged between the adjustable reflective layer and the reactor core, or the adjustable reflective layer is arranged between the fixed reflective layer and the reactor core.

7. The nuclear-energy storage integrated lead-based reactor according to claim 6, wherein the adjustable reflective layer has N rotary arc bodies for reflecting neutrons, and the N rotary arc bodies are arranged at intervals around the reactor core; the fixed reflective layer has N fixed arc bodies for reflecting neutrons, and the N fixed arc bodies are arranged at intervals around the reactor core;
the N fixed arc bodies and the N rotary arc bodies are evenly distributed around the reactor core, and N is a positive integer.

8. The nuclear-energy storage integrated lead-based reactor according to claim 7, wherein a central angle corresponding to one fixed arc body and a central angle corresponding to one rotary arc body are both 180°/N; and/or,
N=4.

9. The nuclear-energy storage integrated lead-based reactor according to claim 3, wherein a neutron shielding layer surrounding the reactor core is provided on the outside of the reactor core, and the fixed reflective layer and the adjustable reflective layer are both located on an inner side of the neutron shielding layer.

10. The nuclear-energy storage integrated lead-based reactor according to claim 1, wherein the thermal energy utilization device comprises a steam generator.
